(19) United States
(12) Patent Application Publication
(10) Pub. No.: US 2015/0106190 A1
(43) Pub. Date: Apr. 16, 2015

(54) ONLINE CAMPAIGN MANAGEMENT

(71) Applicant: Information Resources, Inc., Chicago, IL (US)

(72) Inventors: Chen Wang, Forest Hills, NY (US); Srishti Gupta, West Windsor, NJ (US)

(73) Assignee: Information Resources, Inc., Chicago, IL (US)

(21) Appl. No.: 14/050,427

(22) Filed: Oct. 10, 2013

(51) Int. Cl. G06Q 30/02

(52) U.S. Cl. CPC G06Q 30/0244
USPC 705/14.43

(57) ABSTRACT

Disclosed herein are techniques for identifying customers and their purchasing segments in advance so that advertising impressions can be correlated to the consumers that are being reached by an advertising campaign. A predetermined consumer panel may be characterized by purchasing segment and any other suitable demographics, and tracking techniques such as cookies tied to specific web properties may be used to track online activity by members of the consumer panel. In this manner, each advertising impression for one of the panel members from one of the web properties can be related to a particular purchasing segment, and effectiveness of the campaign can be evaluated based on the types of consumers that are being reached with certain advertisements.

### BACKGROUND

Online advertising campaigns generally employ targeting criteria so that specific advertisements can be directed toward specific types of potential customers. While these campaigns are generally prospective in nature—that is, they provide a priori criteria used to select advertisements prior to display—there remains a need for campaign management tools that permit an analysis of the resulting effectiveness based on what types of customers are actually receiving advertisements.

### SUMMARY

Disclosed herein are techniques for identifying customers and their purchasing segments in advance so that advertising impressions can be correlated to the consumers that are being reached by an advertising campaign. A predetermined consumer panel may be characterized by purchasing segment and any other suitable demographics, and tracking techniques such as cookies tied to specific web properties may be used to track online activity by members of the consumer panel. In this manner, each advertising impression for one of the panel members from one of the web properties can be related to a particular purchasing segment, and effectiveness of the campaign can be evaluated based on the types of consumers that are being reached with certain advertisements.

### BRIEF DESCRIPTION OF THE FIGURES

The invention and the following detailed description of certain embodiments thereof may be understood by reference to the following figures:

FIG. 1 shows entities participating in an online campaign management system.

FIG. 2 shows a method for managing an online advertising campaign.

### DETAILED DESCRIPTION

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus the term “or” should generally be understood to mean “and/or” and so forth.

The following description emphasizes campaign assessment based upon purchasing segments of a consumer panel. While this is a useful application of the tracking techniques disclosed below, it will be understood that the methods and systems described herein have wider applicability, and might be usefully applied in any context where characteristics of a consumer panel can be accurately correlated to advertisements that are selected and displayed during an online advertising campaign. Further, while consumer panels are typically formed of a group of consumers who opt in to a panel and provide purchasing data, purchasing segments or similar characteristics may also or instead be inferred from other data sources, which may be used to form a virtual consumer panel organized by purchasing segment without explicitly gathering purchasing data from specific consumers. All such variations are intended to fall within the scope of this disclosure.

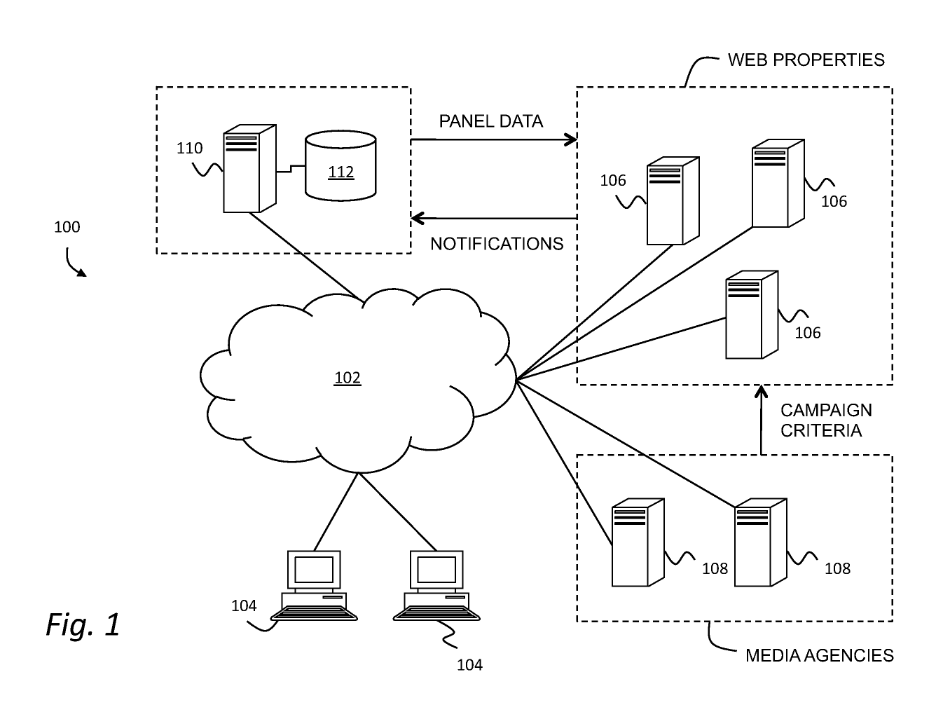

FIG. 1 shows entities participating in an online campaign management system. The system 100 may include a data network 102 such as the Internet that interconnects any number of clients 104, servers 106 for web properties, computers 108 for media agencies, and data sources 110 for panel data.

The data network 102 may include any network or combination of networks suitable for interconnecting other entities as contemplated herein. This may, for example, include the Public Switched Telephone Network, global data networks such as the Internet and World Wide Web, cellular networks that support data communications (such as 3G, 4G and LTE networks), local area networks, corporate or metropolitan area networks, wide area wireless networks and so forth, as well as any combination of the foregoing and any other networks suitable for data communications between the entities depicted in FIG. 1.

The clients 104 may include any device(s) operable by end users (e.g., panel members) to interact with the servers 106 through the data network 102. This may, for example, include a desktop computer, a laptop computer, a tablet, a cellular phone, a smart phone, and any other device or combination of devices similarly offering a processor and communications interface collectively operable as a client device within the data network 102. In general, a client 104 may interact with the servers 106 for the web properties and locally render a user interface such as a web page or the like supporting interaction by the end user with the services and information hosted on the servers 106.

The computers 108 for the media agencies may be any client or server devices suitable for networked interaction with the servers 106 of the web properties to facilitate configuration and execution of online advertising campaigns. This may include an interface for selecting advertising criteria, specifying advertising spend levels, and so forth, as well as tools for monitoring current campaigns or retrieving analytical data concerning past campaigns. While a user interface might usefully employed, it will be understood that data for a campaign may be provided manually, such as in a spreadsheet or text file, which may be manually created or edited according to desired campaign specifications and provided to the media agency (or created by the media agency during an oral interview or the like) and then coded into an advertising platform for execution. It will be appreciated that an online advertising campaign may also or instead be configured through personal or computer interactions with operators of the web properties, and as such the computers 108 for the media agencies may be omitted during configuration of a campaign.

The media agencies may also include third party tracking platforms that are independent of the entity deploying the campaign. For example, a variety of tracking platforms are commercially available that may be used by media agencies and/or web properties to track site traffic (and other aspects of a campaign), and more particularly to detect visits by clients 104 as contemplated herein.

The data source 110 for panel data may be a server maintained by an entity that creates consumer panels for marketing analytics or the like. A consumer panel may be created in a variety of ways, such as by inviting consumers to join a panel during a retail interaction, survey, online interaction, mailed invitation, advertisement, or the like. In general, panel members may be incentivized to participate in a consumer panel using cash, rewards, or any other suitable incentive(s). Each panel member may be added to a database 112 where identifying information for the panel member may be stored along with any relevant data provided by the panel member. The database 112 may also receive and store data obtained about panel member from other sources such as third-party data sources.

As noted above, a virtual consumer panel may also or instead be formed using data from other sources, provided that activity by members of the virtual consumer panel can be detected and accurately correlated to purchasing segments or the like. Thus, a consumer panel may be understood to include any group of purchasers organized according to purchasing segment or similar criteria in a manner that permits detection of activity according to the criteria, without regard to the specific manner in which the consumer panel was created and without regard to whether members explicitly choose to participate in a panel.

Once a consumer panel is created, commercial activity such as online purchases, retail purchases, and so forth may be tracked for panel members, and the database 112 may receive and store data concerning this commercial activity for panel members. Panel members may then be characterized according to purchase history in a variety of ways based upon, e.g., average spend, product mix, and so forth. As discussed below, each panel member may be categorized according to a purchasing segment for a product or product type, and this data may be used in combination with online advertising campaign data to evaluate campaign effectiveness based upon actual ad impressions by known panel members. It will be understood that while an automated collection of panel data is described above, this data may be acquired in a variety of manners, such as by gathering data from individual panel members via manual data feeds or the like. More generally, any suitable technique for gathering and storing panel data that can be used to characterize a purchasing segment for each member may be usefully employed including various automatic, semi-automatic, and manual techniques.

In general, the data source 110 can provide panel data, or simply a list of panel identities, to a server 106 of one of the media properties in order for an operator of the server 106 to create cookies for each member of the panel. Cookies that identify panel members may be distributed to client 104 devices of panel members using a variety of techniques, and may be provided to the panel members through the server 106 or directly from the data source 110. The data source 110 may also provide an interface to a computer 108 for one of the media agencies in order to configure an advertising campaign using web properties represented by the media agencies. It will be understood that while cookies provide one useful tracking mechanism, other tracking techniques may also or instead be used so long as site visits by panel members (or clients 104 associated with panel members) can be detected and correlated back to particular panel members or particular purchasing segments of panel members.

Once panel data has been provided to the server 106 in a manner that permits unique identification of panel members, the server 106 can provide notifications to the data source 110 each time that a panel member visits the server 106 from a corresponding client 104. In this manner, accurate data can be gathered concerning advertising exposure by the panel members for a particular advertising campaign. Similarly, visits may be tracked at the server 106, and a manual or automated data feed may be provided from time to time with aggregated tracking data. The identity of panel members may be obscured in network communications through the use of a unique identifier or the like.

It will be appreciated that a variety of third party tracking services are commercially available, and may be used instead of or in addition to the tracking techniques described above to obtain data concerning network activity that can be correlated to, e.g., particular users, particular client devices, or the like. Such services may be usefully employed to identify panel members during various web interactions and to provide data concerning their activity to the server 106 or other entities involved in campaign management. Similarly, the panel data may be provided to such a third party service for use in tracking activity by panel members.

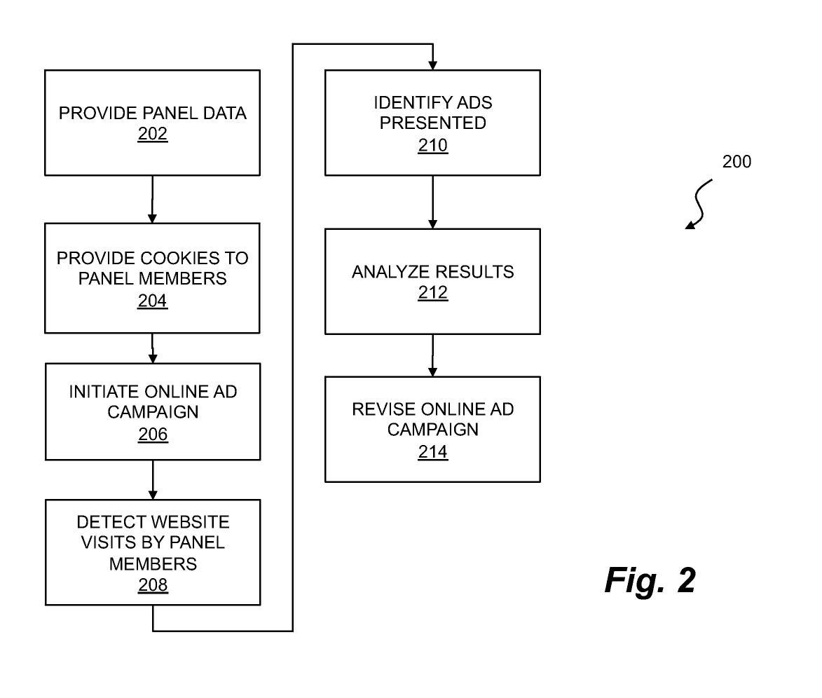

FIG. 2 shows a method for managing an online advertising campaign. In general, panel members may be grouped into predetermined categories such as purchasing segments. Then a tracking technique such as cookies may be used to track various web interactions that expose panel members to advertisements from a campaign.

As shown in step 202, the method 200 may begin with providing data for a panel of consumers, such as from a data source for panel data described above. In general, data for each member of the panel may include one or more predetermined categories into which panel members can be sorted. For example, data may include a purchasing segment that characterizes buying behavior of each member with respect to one or more products. Each panel of consumers may include a panel of uniquely identified consumers to facilitate accurate tracking of individual advertisement impressions across the predetermined categories such as purchasing segment, as well as any other demographic data or other data contained in the panel data.

In general, panel data may be arranged into a variety of categories. This may, for example include two or more categories for purchasing segments tracked within the consumer panel. This may, for example, include two groups, e.g., “category” and “non-category” buyers according to whether the panel member is a regular purchaser of a particular category of good. However, panel members may also or instead by more finely categorized. For example, the purchasing segments may include at least three categories such as a light buyer, a heavy buyer, and a competitive buyer. A heavy buyer, for example, may be an above average purchaser of the targeted brand or product. A light buyer may be a below average purchaser of the targeted brand or product. A competitive buyer may be a known purchaser of a category of product, but not the particular brand or product that is being advertised. Other purchasing segments may also or instead be used, such as a non-category purchaser who does not purchase the particular category of product being advertised. In addition, purchasing segments may be sub-divided or refined according to available data or known consumer behavior. For example, a panel member may be categorized into a purchasing segment such as light-to-medium loyal, that is, a relatively light purchaser of the produce who is known to be loyal to a particular product/brand, or a panel member may be categorized as light-to-medium not loyal as a purchaser that purchases a different brand, or that purchases the category according to other criteria such as price or convenience.

Panel data may also include any other information useful for evaluating consumer activity or campaign effectiveness as contemplated herein. For example, panel data may include age, income, gender, occupation, geographic indicator (such as an address or any other geographic indicator or proxy therefore, such as a town or zip code), and other biographical data. Panel data may also include data in addition to a purchasing segment that characterizes a panel member's purchasing activity such as average spend, product mix, propensity for particular brands, products, or product types, and so forth. This data may be usefully employed instead of or in addition to purchasing segment data to evaluate the effectiveness of an online advertising campaign as contemplated herein.

As shown in step 204, the method may include providing each member of the panel with a cookie for a website. The cookie may specify one or more web properties used in an advertising campaign, and may include several cookies for different web properties. The website may, for example, be a national consumer site, and when the consumer visits the website, the cookie may provide a unique identifier for a panel member that can be detected by the website and used to retrieve data for the panel member from the database provided in step 202. It will be understood that the web property owner may have specific cookie requirements, and the unique identifier may be incorporated into the web property owner's cookie without providing any specific panel data to the web property owner. By positively associating specific panel members with cookies, the methods contemplated herein can advantageously provide highly accurate and specific data concerning which consumers are exposed to which advertisements during a campaign. In another aspect, the cookie may simply identify a purchasing segment for a panel member without uniquely identifying the panel member.

It will be appreciated that a variety of other techniques for tracking online activity are known in the art. This may for example include shared or unique tracking cookies, client-side applications, browser plug-ins, and so forth. Any such techniques suitable for detecting site visits and/or advertising impressions in a manner that can associate an impression with a particular purchasing segment as contemplated herein may be adapted for use with the systems and methods described herein. Thus, while the use of cookies is emphasized in the description, the techniques disclosed herein are not so limited and any suitable tracking technique may be used.

As shown in step 206, the method 200 may include initiating an advertising campaign on the website. The campaign may include one or more advertisements and one or more targeting criteria for presenting the advertisements to a predetermined user type. In general, an online campaign is initiated directly through a web property owner, or through a media agency that can create a media plan and then contract with one or more web property owners to execute the media plan. The online campaign may also or instead use a tracking platform independent of the media agency and property owners to track user interactions with various web content. The media plan may specify keywords or the like that can be used to select specific advertisements to display according to user interactions (e.g., queries or browsing activity) or website-specific cookies containing metadata (or an identifier that can be used to retrieve metadata stored by the web property owner) about the user. Techniques for creating advertising campaigns and targeting advertisements are known in the art, and additional details are not provided here, except to note generally that the web property owner (or other relevant entity that controls advertising buys, such as a demand-side platform (DSP) or the like) uses targeting criteria specified in an advertising campaign to select advertisements for a particular website visitor and interaction.

In one aspect, initiating a campaign may include concurrently initiating the advertising campaign on two or more different websites such as multiple web properties of a single property owner, multiple web properties coordinated through a single media agency, multiple web properties coordinated through different media agencies, or some combination of these. In this manner, comparative data can be obtained and used to evaluate different media channels or dynamically revise an advertising campaign as discussed in greater detail below.

As shown in step 208, the method 200 may include detecting visits to the website by members of the panel. This may be based upon cookies or any other suitable tracking technology. The detection may be recorded and shared in a variety of ways according to a particular deployment of the system described herein. For example, data and code for purchase segment evaluation may be deployed on a server hosted by the web property owner, or the data and code may be hosted remotely, e.g., at a server operated by the entity that creates the consumer panel. In this latter configuration, detecting visits may include receiving a notification from the operator of the website relating to the visit, which may be a single notification for each such visit (e.g., streamed data), or aggregate statistics for the visits over some predetermined time period, or some combination of these. In one aspect, the notification may include data characterizing panel member activity and non-panel member activity. For example, the notification may include aggregate statistics for non-panel members over a specific time period such as the time period corresponding to the time period used to gather statistics for panel members. This approach advantageously facilitates direct comparison of panel data to non-panel data. The notification may also or instead directly report a relative number or proportion of visitors to the website that belong to the panel. Data about non-panel member activity permits a variety of analyses, e.g., to draw inferences about non-panel member characteristics (by comparison to panel members), to evaluate statistical reliability of the panel data, or to identify potential statistical bias in the panel data.

As shown in step 210, the method 200 may include identifying one or more advertisements presented to the members of the panel. In one aspect, this may include adding information to the notification described above that identifies one or more advertisements presented to a particular one of the members of the panel. In this manner, specific data may be obtained detailing which advertisement(s) a particular member of the consumer panel was exposed to. In this context, the notification may also or instead identify advertisements presented to a particular one of the purchasing segments so that an advertising campaign can be evaluated for effectiveness in reaching a desired purchased segment.

Other contextual data for each ad impression may also be captured, such as a time, related web-browsing activity, and so forth. Where available, this may also include data characterizing any resulting consumer activity such as whether the consumer interacted with the advertisement and/or purchased related products.

As shown in step 212, the method may include analyzing results. This may for example include correlating the one or more advertisements to one or more purchasing segments for the panel, thereby providing a campaign result organized according to the one or more purchasing segments, or more generally to any predetermined categories for members of the panel. This analysis may also or instead include correlating the one or more advertisements to demographics attributes of the panel, or any other suitable analysis. Thus, while the above process specifically contemplates the determination of purchasing segments, additional analyses may also usefully be performed.

In another aspect, analyzing the results may include evaluating an effectiveness of the advertising campaign at reaching one or more predetermined ones of the purchasing segments based upon the campaign result. Thus for example, a campaign intended for heavy buyers may be targeted using one or more keywords or the like on a web property. The campaign objectives may then be reviewed against panel members that were exposed to the resulting advertisements to determine which purchasing segments were actually viewing the targeted advertisements. Similarly, each access by a panel member (in step 208) who is known to be a corresponding heavy buyer may be analyzed to evaluate whether that panel member is receiving the desired advertisement. It will be appreciated that a cookie that identifies a panel member may, in certain embodiments, be used to select a particular advertisement such as one of the targeted advertisements from the online campaign, but this step would be implemented by the media property that is executing the advertising campaign and is independent of the panel member activity analysis contemplated herein, which provides a retrospective analysis of panel member advertising impressions rather than a prospective technique for selecting advertisements.

In order to evaluate the effectiveness of a campaign, the effectiveness may include one or more thresholds for characterizing success of the campaign. For example, the effectiveness may include a threshold based upon an absolute number of advertisement exposures to the one or more predetermined ones of the purchasing segments. The effectiveness may also or instead include a threshold based upon a relative number of advertisement exposures to the one or more predetermined ones of the purchasing segments, or any other quantitative threshold representative of whether and to what extent advertisements are reaching the intended or desired audience.

In another aspect, analyzing the results may include comparing an effectiveness of the advertising campaign (at reaching one or more predetermined ones of the purchasing segments) across different websites, thus providing a relative effectiveness, e.g., for each of the different advertising channels and/or each of the different purchasing segments. It will be appreciated that a variety of such comparisons might be made. For example, it may be determined that one advertising channel reaches a greater absolute number of panel members while another advertising channel reaches relatively more panel members from a desired purchasing segment. This data may be used to adjust advertising spend across different websites or advertising channels to improve the reach of an advertising campaign toward a desired audience.

As shown in step 214, the process 200 may include revising an online campaign. In general, this may include a variety of techniques such as changing targeting criteria, or expanding or changing web properties, media agencies or the like, or changing a spending mix across a variety of advertising channels. For example, revising the online campaign may include transferring the advertising campaign to a different website when the effectiveness is below a predetermined threshold. In another aspect, this may include reallocating an advertising spend between two or more different websites based upon a relative effectiveness for each of the websites. Similarly, revising the online campaign may include selecting at least one additional website for the advertising campaign when an aggregate effectiveness of the advertising campaign on two or more different websites for a current campaign is below a predetermined threshold. Such adjustments may in general be made dynamically, e.g., while an advertising campaign is underway, or after one campaign is completed and before a new, similar campaign is initiated.

In another aspect, revising the campaign may include changing a targeting criterion for delivery of advertisements in the advertising campaign. For example, where it can be inferred from the effectiveness of the campaign that advertisements are not reaching an intended or desired purchasing segment, the price paid for placement may be increased or decreased. For example, the price may be increased in order to reach more visitors to the website, or decreased in order to increase an advertising spend elsewhere. Similarly, the selection of keywords or other criteria used to target advertisements may be modified in an effort to reach different site visitors. More generally, any modification in targeting criteria that that might be expected to change the audience reached by a particular advertisement may be adapted or optimized to improve (or to attempt to improve) the effectiveness of the campaign.

The methods or processes for providing same as described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors, or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

It should further be appreciated that the methods above are provided by way of example. Absent an explicit indication to the contrary, the disclosed steps may be modified, supplemented, omitted, and/or re-ordered without departing from the scope of this disclosure.

The method steps of the invention(s) described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps.

While particular embodiments of the present invention have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method comprising:
providing data for a panel of consumers, the data for each member of the panel including a purchasing segment that characterizes buying behavior of the member with respect to one or more products;
initiating an advertising campaign on a website, the advertising campaign including one or more advertisements and one or more targeting criteria for presenting the advertisements to a predetermined user type;
detecting a visit to the website by a member of the panel;
identifying one or more advertisements presented to the member of the panel during the visit; and
correlating the one or more advertisements to the purchasing segment for the member of the panel, thereby providing a campaign result.

2. The method of claim 1 further comprising:
detecting a number of visits to the website by a number of members of the panel;
correlating a number of advertisements to a number of purchasing segments for the number of members of the panel, thereby providing a result; and
organizing the result according to the number of purchasing segments.

3. The method of claim 1 further comprising:
providing each member of the panel with a cookie for the website; and
detecting visits to the website by members of the panel based upon the cookies.

4. The method of claim 1 wherein detecting visits includes receiving a notification from an operator of the website.

5. The method of claim 4 wherein the notification includes aggregate statistics for the visits.

6. The method of claim 4 wherein the notification identifies advertisements presented to a particular one of the members of the panel.

7. The method of claim 4 wherein the notification identifies advertisements presented to a particular one of the purchasing segments.

8. The method of claim 4 wherein the notification includes aggregate statistics for non-panel members over a corresponding time period.

9. The method of claim 4 wherein the notification includes a relative number of visitors to the website that belong to the panel.

10. The method of claim 1 wherein the number of purchasing segments include at least three categories.

11. The method of claim 10 wherein the at least three categories include a light buyer, a heavy buyer, and a competitive buyer.

12. The method of claim 1 wherein data for the panel includes demographic attributes of the panel.

13. The method of claim 12 further comprising correlating the one or more advertisements to the demographic attributes of the panel.

14. The method of claim 1 wherein the panel of consumers includes a panel of uniquely identified consumers.

15. The method of claim 2 further comprising evaluating an effectiveness of the advertising campaign at reaching one or more predetermined ones of the purchasing segments based upon the campaign result.

16. The method of claim 15 wherein the effectiveness includes a threshold based upon an absolute number of advertisement exposures to the one or more predetermined ones of the purchasing segments.

17. The method of claim 15 wherein the effectiveness includes a threshold based upon a relative number of advertisement exposures to the one or more predetermined ones of the purchasing segments.

18. The method of claim 15 further comprising transferring the advertising campaign to a different website when the effectiveness is below a predetermined threshold.

19. The method of claim 15 further comprising changing a targeting criterion for delivery of advertisements in the advertising campaign when the effectiveness is below a predetermined threshold.

20. The method of claim 1 further comprising concurrently initiating the advertising campaign on two or more different websites.

21. The method of claim 20 further comprising comparing an effectiveness of the advertising campaign at reaching one or more predetermined ones of the purchasing segments, thereby providing a relative effectiveness.

22. The method of claim 21 further comprising reallocating an advertising spend between the two or more different websites based upon the relative effectiveness.

23. The method of claim 21 further comprising selecting at least one additional website for the advertising campaign when an aggregate effectiveness of the advertising campaign on the two or more different websites is below a predetermined threshold.
